(19) United States
(12) Patent Application Publication
(10) Pub. No.: US 2026/0119603 A1
(43) Pub. Date: Apr. 30, 2026

(54) TRAINING A LONG CONTEXT TRANSFORMER USING OVERLAPPING COMMUNICATION AND COMPUTATION

(71) Applicant: Microsoft Technology Licensing, LLC, Redmond, WA (US)

(72) Inventors: Venmugil ELANGO, Redmond, WA (US); Gaurav Sadanand KOLHE, Redmond, WA (US)

(21) Appl. No.: 18/926,219

(22) Filed: Oct. 24, 2024

(51) Int. Cl. G06F 17/16

(52) U.S. Cl. CPC G06F 17/16

(57) ABSTRACT

Techniques for improving the training and prompt phase inferencing of a long sequence transformer are disclosed. A service shards an activation matrix and a weight matrix into chunks. The service distributes the activation matrix chunks and the weight matrix chunks to multiple computer systems. The activation matrix chunk remains stationary at each computer system. The weight matrix chunks, on the other hand, are subjected to a gathering operation in which each weight matrix chunk is used for a matrix multiplication operation against the activation matrix chunk and then replaced by a newly acquired weight matrix chunk. While the matrix multiplication operation is occurring, the service transmits the current weight matrix chunk to a new computer system and receives a new weight matrix chunk from another computer system.

### BACKGROUND

Transformer models have shown tremendous success in highlighting exceptional performance across a wide range of artificial intelligence (AI) applications. Transformer models have also emerged as the architecture of choice in applications such as natural language processing (NLP) and image classification.

“Long sequence” (aka “long context”) transformers are one specific type of transformer. These types of transformers tackle a diverse array of AI challenges, ranging from processing books and high-resolution images to analyzing long videos and complex codebases.

Due to memory constraints, long sequence transformers are typically trained and inferenced in a distributed setup involving multiple graphics processing units (GPUs). With this setup, communication between the GPUs often becomes the primary bottleneck. Traditional parallelism schemes, such as “tensor parallelism,” incur significant communication costs, thereby leading to long training and inference times. What is needed, therefore, is an improved parallelization scheme for training and prompt-phase inferencing of long sequence transformers.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to a computer system including: a processor system; and a storage system that includes instructions that are executable by the processor system to cause the computer system to: shard an activation matrix along a first dimension, resulting in a plurality of activation matrix chunks being created; distribute the plurality of activation matrix chunks to a plurality of computer systems, which include said computer system, such that each computer system in the plurality is provided a corresponding activation matrix chunk and such that said computer system retains a first activation matrix chunk; shard a weight matrix along a second dimension, resulting in a plurality of weight matrix chunks being created; distribute the plurality of weight matrix chunks to the plurality of computer systems, such that each computer system in the plurality is provided a corresponding weight matrix chunk and such that said computer system retains a first weight matrix chunk; perform a first matrix multiplication operation using the first activation matrix chunk and the first weight matrix chunk; concurrently with performing the first matrix multiplication operation, transmit the first weight matrix chunk to a first neighboring computer system, which is included among the plurality of computer systems; accumulate, at an output tensor, a first result of performing the first matrix multiplication operation; replace the first weight matrix chunk with a second weight matrix chunk that is received from the first neighboring computer system; repeat the first matrix multiplication operation using the first activation matrix chunk and the second weight matrix chunk; and accumulate, at the output tensor, a second result of performing the second matrix multiplication operation.

In some aspects, the techniques described herein relate to a method including: sharding an activation matrix along a first dimension, resulting in a plurality of activation matrix chunks being created; distributing the plurality of activation matrix chunks to a plurality of computer systems, which include a computer system, such that each computer system in the plurality is provided a corresponding activation matrix chunk and such that said computer system retains a first activation matrix chunk; sharding a weight matrix along a second dimension, resulting in a plurality of weight matrix chunks being created; distributing the plurality of weight matrix chunks to the plurality of computer systems, such that each computer system in the plurality is provided a corresponding weight matrix chunk and such that said computer system retains a first weight matrix chunk; performing a first matrix multiplication operation using the first activation matrix chunk and the first weight matrix chunk; concurrently with performing the first matrix multiplication operation, transmitting the first weight matrix chunk to a first neighboring computer system, which is included among the plurality of computer systems; accumulating, at an output tensor, a first result of performing the first matrix multiplication operation; replace the first weight matrix chunk with a second weight matrix chunk that is received from the first neighboring computer system; repeating the first matrix multiplication operation using the first activation matrix chunk and the second weight matrix chunk; and accumulating, at the output tensor, a second result of performing the second matrix multiplication operation.

In some aspects, the techniques described herein relate to one or more hardware storage devices that store instructions that are executable by one or more processors to cause the one or more processors to: shard an activation matrix along a first dimension, resulting in a plurality of activation matrix chunks being created; distribute the plurality of activation matrix chunks to a plurality of computer systems, which include a computer system, such that each computer system in the plurality is provided a corresponding activation matrix chunk and such that said computer system retains a first activation matrix chunk; shard a weight matrix along a second dimension, resulting in a plurality of weight matrix chunks being created; distribute the plurality of weight matrix chunks to the plurality of computer systems, such that each computer system in the plurality is provided a corresponding weight matrix chunk and such that said computer system retains a first weight matrix chunk; perform a first matrix multiplication operation using the first activation matrix chunk and the first weight matrix chunk; concurrently with performing the first matrix multiplication operation, transmit the first weight matrix chunk to a first neighboring computer system, which is included among the plurality of computer systems; accumulate, at an output tensor, a first result of performing the first matrix multiplication operation; replace the first weight matrix chunk with a second weight matrix chunk that is received from the first neighboring computer system; repeat the first matrix multiplication operation using the first activation matrix chunk and the second weight matrix chunk; and accumulate, at the output tensor, a second result of performing the second matrix multiplication operation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a replicated activation matrix and a sharded weight matrix approach to train a long sequence transformer.

FIG. 2 illustrates a sequence parallelism approach to train a long sequence transformer.

FIG. 3 illustrates an example computing architecture designed to improve how long sequence transformers are trained.

FIGS. 4A and 4B illustrate an improved approach to training a long sequence transformer, where this improved approach involves sharding the activation matrix and sharding the weight matrix.

FIG. 5 illustrates the overlapping communication and computation actions that occur when implementing the improved training approach.

FIG. 6 illustrates also illustrates the overlapping communication and computation actions.

FIGS. 7A and 7B illustrate flowcharts of an example method for improving how long sequence transformers are trained and inferred during their prompt phases.

FIG. 8 illustrates an example computer system that can be configured to perform any of the disclosed operations.

### DETAILED DESCRIPTION

As mentioned above, traditional parallelism schemes, such as tensor parallelism, incur significant communication costs. The traditional tensor parallelism scheme is primarily designed for short sequence transformers, not for long sequence transformers. The communication costs associated with the traditional approach lead to overly prolonged training and inference times when applied to long sequence scenarios. What is needed, therefore, is an improved parallelization scheme for training and inferring (during a prompt phase) a long sequence transformer.

The disclosed embodiments are directed to an improved parallelization scheme for long sequence transformers. This improved approach allows for lower communication costs when implementing long sequence training and inference operations.

Beneficially, the disclosed techniques can achieve a communication cost of O(h²) as opposed to a communication cost of O(S*h) incurred by traditional tensor parallelism, where “S” is the sequence length and “h” is the hidden dimension size. Later, reference is also made to a “B” dimension, which refers to a batch dimension. It should be noted how the sharding operations described herein operate per batch. Generally, it is preferable to fold or flatten the “B” dimension into the “S” dimension and consider the disclosed activation matrices as just being two dimensional matrices (i.e. S*h). In long sequence length regimes, where S>>h, the disclosed techniques can achieve orders of magnitude lower communication cost compared to previous techniques. Later, reference is also made to a “P” value, which refers to the number of processors or devices that are available to perform work.

To further reduce the memory and communication cost, the embodiments are beneficially designed to “tile” (i.e. “shard,” “split,” or “divide”) the computation into smaller “chunks” (also called “tiles,” “splits,” or “shards”). As another unique benefit, the embodiments can overlap the computation operations and the communication operations such that the embodiments effectively hide at least some of the communication cost behind the computations.

As another benefit, the disclosed parallelization scheme can be implemented using an inexpensive (i.e. sparse) one-dimensional (1-D) ring network topology for conflict-free communication. In this sense, the disclosed embodiments provide significant improvements, advantages, and practical applications in machine learning (ML), particularly during the training and inferencing operations of long sequence transformers. Stated differently, the embodiments improve training and inferencing efficiency in large language models (LLMs). The disclosed principles can be employed to train larger models with better accuracy and in a shorter amount of time. During inferencing operations, the disclosed operations can also help reduce the inference latency, thereby providing a better user experience. Accordingly, these and numerous other benefits will now be described in more detail throughout the remaining portions of this disclosure.

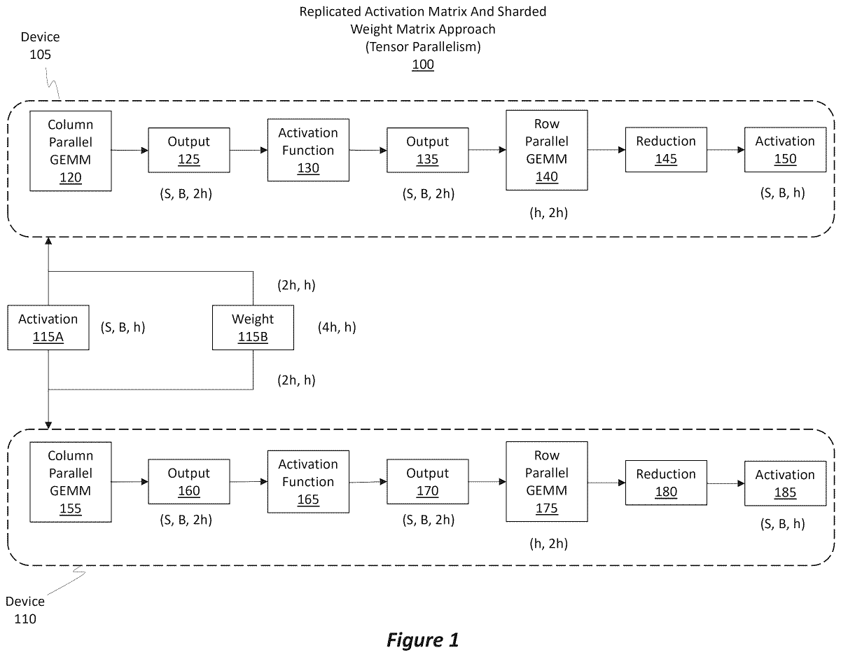

Having just described some of the high-level benefits of the disclosed principles, attention will now be directed to FIG. 1. FIG. 1 illustrates an example replicated activation matrix and sharded weight matrix approach 100 involving a traditional parallelism scheme. This illustration is provided to help provide an initial understanding of the operations disclosed herein.

Notably, FIG. 1 illustrates a scenario where an activation matrix of the neural network (i.e. the long sequence transformer) is replicated (i.e. copied) and transmitted to each device that is available to perform work in the network. A weight matrix of the neural network is sharded and then transmitted to the devices. This parallelism scheme requires a higher communication bandwidth because of the large size of the activation matrix. Notice, FIG. 1 shows operations performed on two different devices, such as device 105 and device 110.

In more detail, an activation matrix 115A is provided to both device 105 and device 110. In other words, the activation matrix 115A is replicated (in its entirety) to both device 105 and device 110. This activation matrix 115A has dimensions (S, B, h), as shown in FIG. 1.

The weight matrix 115B, on the other hand, is sharded. Originally, the dimensions of the weight matrix 115B are (4h, h). When sharded and distributed between the two devices 105, 110, the dimensions of each chunk of the weight matrix are (2h, h).

One shard of the weight matrix 115B is distributed to device 105. Another shard of the weight matrix 115B is distributed to device 110. Thus, as mentioned above, the weight matrix 115B, during the sharding process, is divided into matrices having the following dimensions: (2h, h).

In the figures, reference is made to an operation involving a “GEMM. ” As used herein, “GEMM” stands for “general matrix multiplication” and refers to a matrix multiplication operation between two matrices, such as the activation matrix and the weight matrix (or a chunk of the weight matrix). Reference is also made to an “activation function,” which refers to a pointwise activation computation performed on the resulting activation matrix (resulting from the GEMM operation). The activation function is structured to calculate the output of a node based on the various different inputs and weights.

Returning to FIG. 1, device 105 then performs a column parallel GEMM 120 operation using the replicated activation matrix and the sharded portion of the weight matrix. The output of that GEMM operation is shown as output 125, which is then subjected to the activation function 130 (i.e. a pointwise activation computation). The output of the activation function 130 is shown as output 135 and has dimensions (S, B, 2h).

Device 105 then performs a row parallel GEMM 140 operation on the output 135, resulting in an activation matrix having dimensions (S, B, h). Recall, the weight matrix chunk that device 105 is using still has the dimensions (h, 2h) (transposed version). After performing the row parallel GEMM 140 operation, now device 105 (and also device 110) has partial results. The results are partial due to the operations being performed using only a chunk, and not the entirety, of the weight matrix.

A reduction 145 is then performed by device 105. The reduction 145 is performed to obtain a global final result by facilitating communications between the devices 105 and 110. That is, device 105 transmits its partial results to device 110, and device 110 transmits its partial results to device 105. Thus, at this point, a communication occurs between the devices, and the communication cost is the size of the activation matrix, which is generally quite large. In this scenario, it is desirable for each device to include the full version of the activation matrix. Thus, each device then combines its now-obtained partial results into a global result. The global result results in the generation of the activation matrix 150 having dimensions (S, B, h).

Similar operations are performed by device 110, as shown by the column parallel GEMM 155 operation, the output 160, the activation function 165, the output 170, the row parallel GEMM 175 operation, the reduction 180, and the activation matrix 185. The above process generally describes tensor parallelism and will return diminishing performance as the value “S” increases. In fact, the communication cost will be S*B*h, where the value “B” is the batch dimension. Therefore, as the sequence dimension “S” becomes larger, the communication costs significantly increase using the tensor parallelism technique shown in FIG. 1.

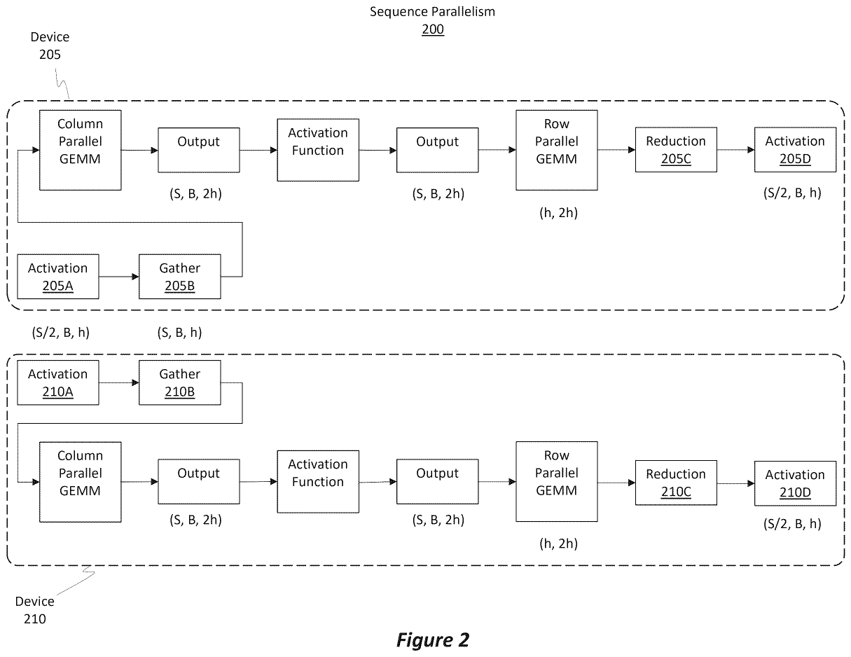

FIG. 2 shows an alternative, hybrid approach involving sequence parallelism 200. Here again, the communication cost is S*B*h. In this scenario, each device initially receives or has access to a portion of the activation matrix, such as half of the activation matrix. However, with this implementation, the entirety of the activation matrix is needed, so each device performs an initial gathering operation to collect the missing portion of the activation matrix. The gather operation also involves collecting the missing portions of the weight matrix.

Thus, in FIG. 2, the devices initially have a portion of an activation matrix, where that portion has dimensions (S/2, B, h). Subsequently, however, during the gather operations, the devices gather the remaining portions of the activation matrix. Thus, in this scenario, attempts were made to try to shorten the activation matrix, as shown by splitting the sequence dimension in half.

In more detail, FIG. 2 shows two devices, namely, device 205 and device 210. Similar operations are performed in the sequence parallelism 200 of FIG. 2 as to the replicated activation matrix and sharded weight matrix approach 100 of FIG. 1, with the primary difference occurring at the beginning of the process flow. In particular, device 205 receives or has access to an activation matrix 205A having dimensions (S/2, B, h). Device 205 then performs a gather 205B operation to gather the additional portions of the full activation matrix; this gather 205B operation is performed along the first dimension. The result of the gather 205B operation is that device 205 now has the full activation matrix having the following dimensions: (S, B, h). The gather 205B operation also includes gathering the missing portions of the weight matrix. The next few operations are the same as those in FIG. 1 and will not be repeated.

In the reduction 205C operation, however, device 205 reduces the activation matrix along the first dimension. The result of the reduction 205C is an activation matrix 205D having dimensions (S/2, B, h). Similar operations are performed by device 210, as shown by activation matrix 210A, gather 210B, reduction 210C, and activation matrix 210D. Improvements upon these various techniques will now be recited using the subsequent figures.

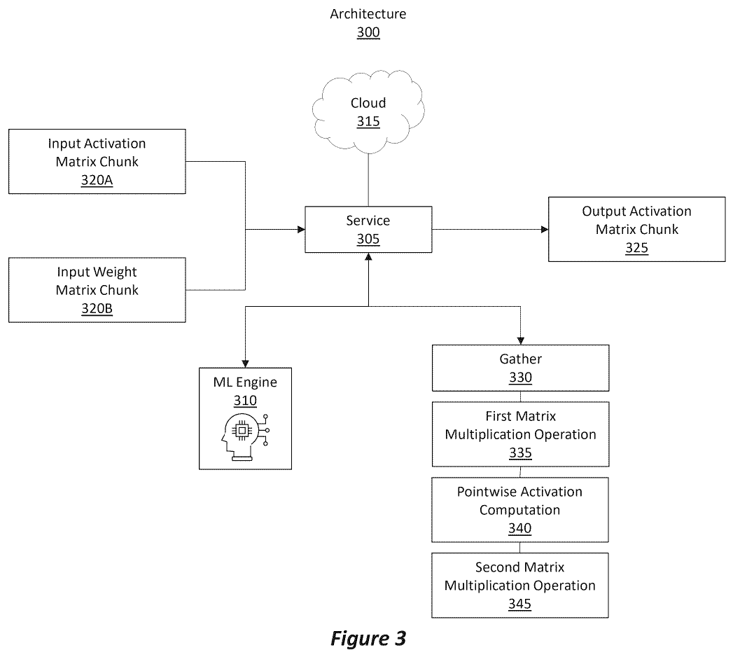

FIG. 3 shows an example computing architecture 300 having a service 305. As used herein, the term “service” refers to an automated program that is tasked with performing different actions based on input. In some cases, service 305 can be a deterministic service that operates fully given a set of inputs and without a randomization factor. In other cases, service 305 can be or can include a machine learning (ML) or artificial intelligence engine, such as ML engine 310. The ML engine 310 enables the service 305 to operate even when faced with a randomization factor.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 305 is a cloud service operating in a cloud 315 environment. In some implementations, service 305 is a local service operating on a local device, such as any of the devices mentioned earlier. In some implementations, service 305 is a hybrid service that includes a cloud component operating in the cloud 315 and a local component operating on a local device. These two components can communicate with one another.

Service 305 is tasked with receiving or accessing (or even creating) an input activation matrix chunk 320A and an input weight matrix chunk 320B. The input activation matrix chunk 320A remains stationary on the device hosting service 305. The input weight matrix chunk 320B, on the other hand, will be replaced with chunks obtained from other devices/processors in the network.

Service 305 is tasked with using the input activation matrix chunk 320A and the input weight matrix chunk 320B (as well as any other weight matrix chunks service 305 obtained) to generate an output activation matrix chunk 325. The operations performed by service 305 are performed in a manner that reduces communication and computation costs. More specifically, service 305 computes a forward and backward pass of linear layers in the long sequence transformer.

To do so, service 305 (as step one) splits a full activation matrix along its sequence length dimension. Service 305 then equally distributes the split matrices (i.e. activation matrix chunks) among the available devices in the network. This distribution can be either in block or cyclic fashion. Service 305 also retains one of the activation matrix chunks, as shown by input activation matrix chunk 320A.

Service 305 (as step two) also splits a full weight matrix along its reduction dimension. Service 305 then equally distributes the split weight matrices (i.e. weight matrix chunks) among the available devices in the network. This distribution can be either in block or cyclic fashion. Service 305 also retains one of the weight matrix chunks, as shown by input weight matrix chunk 320B.

In the background, service 305 (and each processor of each device in the network) asynchronously starts to send (as step three) its block of input weights (i.e. its weight matrix chunk) to a neighboring processor (e.g., perhaps a previous neighboring processor) and receives a new weight matrix chunk from another device/processor. This constitutes a so-called “gather” step, as shown by gather 330. The communication involves a near neighbor data exchange, and a simple sparse ring network topology is sufficient.

Concurrently, as step four, service 305 (and each device in the network) begins performing a first matrix multiplication operation 335 using its respective chunk of the activation matrix and its current respective chunk of the weight matrix. While the first matrix multiplication operation 335 is ongoing, service 305 also facilitates sending its original input weight matrix chunk 320B to a new device in the network. Also, while the first matrix multiplication operation 335 is ongoing, service 305 facilitates obtaining a new input weight matrix chunk from another device in the network. Thus, the communications and computations are performed in an overlapping, simultaneously, concurrent, or parallel manner. By “overlapping,” it is generally meant that at least at one point in time, both the computations and the communications are occurring.

Regarding the matrix multiplication, the matrix multiplication operations are performed on the block of local activations and weights each device already owns. The results of the matrix multiplication computations are accumulated (summed) to the output tensor.

As step five, after the background communication completes, its local weights are replaced with newly received weight matrix chunk data, as described below. Steps three, four, and five are repeated until all input blocks are finished processing. Thus, each device, at any given point in time, will retain no more than two chunks of the weight matrix, with one chunk being the one that is currently involved in the matrix multiplication and the other chunk being one that is newly received from another device.

After receiving the new input weight matrix chunk from the other device, service 305 again facilitates the first matrix multiplication operation 335 using the input activation matrix chunk 320A and the new input weight matrix chunk. While this matrix multiplication is ongoing, service 305 facilitates another send/receive operation of weight matrix chunks. Service 305 will repeatedly perform the first matrix multiplication operation 335 on the input activation matrix chunk 320A until such time as all of the chunks of the weight matrix have been obtained and multiplied against the input activation matrix chunk 320A. Thus, the matrix multiplication operations and the send/receive operations are performed in an overlapping manner.

After the full set of weight matrix chunks have been multiplied against the input activation matrix chunk 320A, a resulting activation matrix is generated. This resulting activation matrix is then subjected to a pointwise activation computation 340 performed by an activation function node. The output of the activation function node is then subjected to a second matrix multiplication operation 345, and the output of that second matrix multiplication operation 345 is the output activation matrix chunk 325.

The operations involved with the second matrix multiplication operation 345 are substantially the same as the operations involved with the first matrix multiplication operation 335. In particular, the weight matrix of the second GEMM (i.e. the second matrix multiplication operation 345) is typically of size (4h, h), which is sharded along the first dimension. When there are “P”devices, each device has a weight shard of size (4h/P, h).

The activations that arrive at the input of the second GEMM are already sharded, since the first GEMM (i.e. the first matrix multiplication operation 335) and the pointwise activation computation 340 were performed in a sharded fashion. Each activation shard is of size (S/P, B, 4h). Each device then performs its computation in an activation stationary fashion, similar to the first GEMM. Activation shards stay stationary on each device, while the weights are communicated in a ring fashion overlapping with the computation.

The difference between the two GEMMs is the size of the activation and weight matrices. For the first GEMM, the sharded input activation is typically of size (S/P, B, h) and sharded weight is of size (h/P, 4h). The output activation that gets generated is of size (S/P, B, 4h). For the second GEMM, the sharded input activation is of size (S/P, B, 4h), sharded weight is of size (4h/P, h) and the generated output activation is of size (S/P, B, h). The result of performing the second matrix multiplication operation 345 is the output activation matrix chunk 325.

With this approach, only the weight tensors (that were distributed in step (2)) are communicated, while the activation tensors (that were distributed in step (1)) stay stationary. In contrast, previous works that are based on tensor parallelism keep the weight tensors stationary and communicate the activation tensors. Such an approach was workable for a short sequence transformer, but that approach is not optimal for a long sequence transformer.

Because the weight tensors are orders of magnitude smaller than activation tensors for long sequence lengths, the disclosed approach is able to achieve lower communication cost in the long sequence length regime. A similar approach is applied in the backward pass as well.

Data parallelism is a common parallelization technique used for parallel training/inferencing of machine learning models. However, as mentioned above, data parallelism replicates the whole weight tensor among all processors. For large language models and long sequence length models, memory is a major constraint. Thus, the model is typically not fit in the process memory through replication.

This shortcoming of data parallelism can partially be overcome by sharding (instead of replicating) the weights among different processors, as was generally described in FIG. 1. However, unlike the disclosed approach, sharding alone does not consider hiding the communication by interleaving and overlapping communication with computation.

Additionally, with traditional data parallelism, the full weight tensor of a single linear layer has to be gathered and stored by each device/processor before the computation begins. Instead, in the disclosed approach, only two shards of the weight tensor are stored at any given time, thus using less memory. For long sequence length models, tensor parallelism leads to significantly high communication cost. In contrast, the disclosed embodiments keep the activations stationery and communicate the weights. Stated differently, with the disclosed embodiments, the weight tensors are fully split and distributed instead of being replicated, and the communication operations are interleaved and caused to overlap with the computations.

In this manner, service 305 of FIG. 3 uses an activation stationary and weight non-stationary parallelization scheme instead of an activation non-stationary and weight collectivization scheme. The weight non-stationary parallelization scheme reduces the communication cost of training and inferencing large language models with long sequence lengths. Service 305 also uses tiling and pipelining to break the communication and computation into smaller tiles/chunks and interleaves them to overlap and hide the communication cost behind computation.

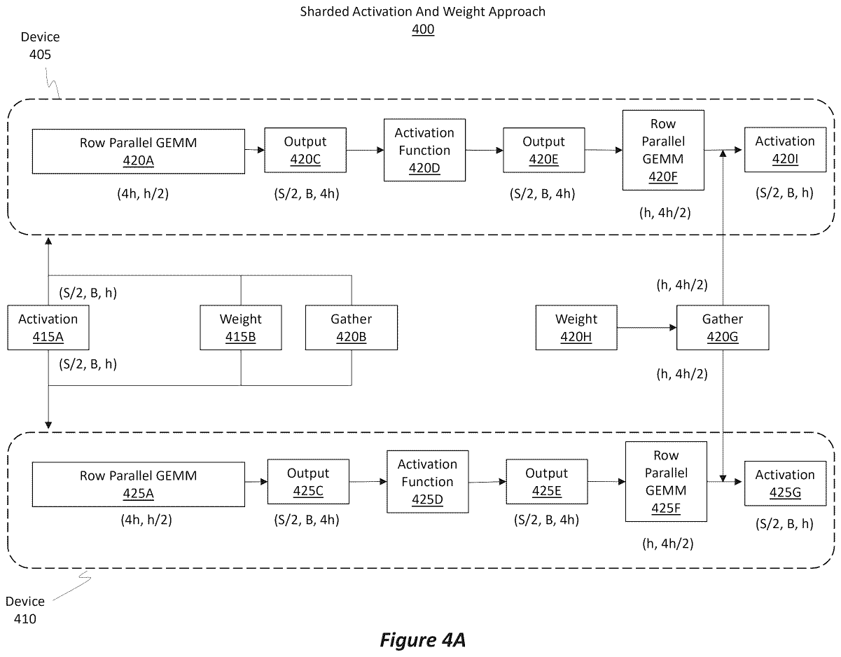

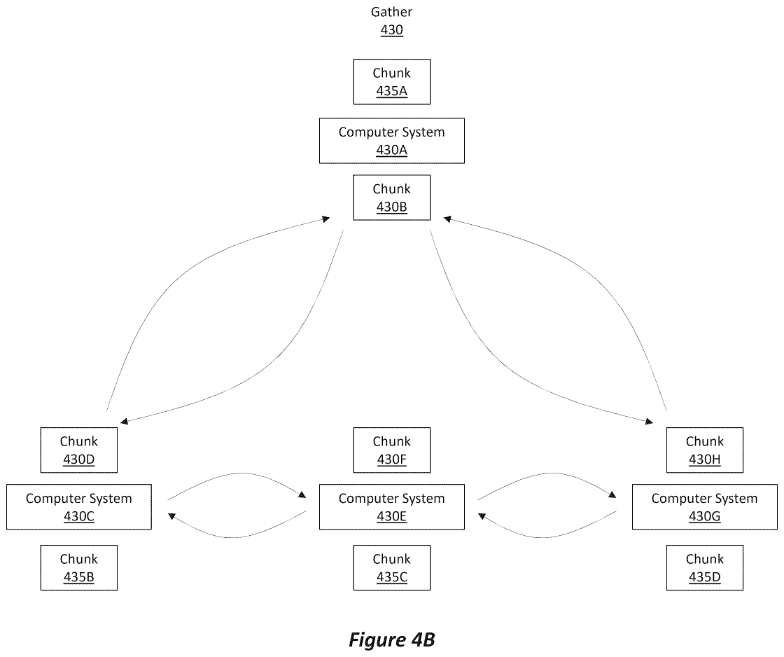

To better describe these operations, attention will now be directed to FIG. 4A, which illustrates an improved sharded activation and weight approach 400 that can be implemented by service 305, which may be running on the device 405 and/or the device 410 of FIG. 4A. With the approach shown in FIG. 4A, the embodiments use row parallel GEMM instead of column plus row parallel GEMM. Also, it should be noted how the illustrated gathering operations happen on the weight matrix chunks. By performing these operations, the communication cost can be reduced to 4h*h, because communications can be saved or reduced by communicating a smaller weight matrix. FIG. 4A does not particularly illustrate the overlapping aspect mentioned earlier, but FIG. 4B does particularly illustrate the overlapping nature of the embodiments.

In FIG. 4A, two devices are shown, such as device 405 and device 410. It will be appreciated how any number of devices can be included in the disclosed scenarios. Initially, as shown in FIG. 4A, the activation matrix 415A, which has dimensions (S, B, h), is sharded/split along the sequence length dimension “S” and equally distributed among all the available processors in the network. In this example scenario, there are two available processors on two different devices (i.e. devices 405 and 410). Also, the weight matrix 415B is sharded/split along its reduction dimension and equally distributed among the available processors.

The processor of device 405 will, as a background operation, asynchronously send its block of input weights (i.e. its weight matrix chunk) to the previous neighboring processor, which is the one in device 410. Similarly, the processor of device 410 will also, as a background operation, asynchronously send its block of input weights to its previous neighboring processor, which is the one in device 405. Such operations, which occur during the first matrix multiplication operation, are reflected by the “gather” 420B block illustrated in FIG. 4A and will now be described in more detail.

In particular, device 405 receives its respective chunk allotment of the activation matrix 415A and the weight matrix 415B. Device 405 then performs a row parallel GEMM operation 420A, which involves matrix multiplying the activation matrix chunk against a first weight matrix chunk. During the matrix multiplication, device 405 also gathers (e.g., as shown by gather 420B) a second weight matrix chunk from a neighboring node, such as device 410. The activation matrix chunk on device 405 remains stationary. At any given time, no more than two chunks of the weight matrix are stored on device 405. Similarly, at any given time, no more than two chunks of the weight matrix are stored on device 410.

After the second weight matrix chunk is gathered, the row parallel GEMM operation 420A is again performed using the activation matrix chunk and the second weight matrix chunk. Subsequently, if more chunks are available, another weight matrix chunk is obtained, and the row parallel GEMM operation 420A operation is repeated between the activation matrix chunk and this new weight matrix chunk. This process is performed until all weight matrix chunks have been executed by device 405 against its activation matrix chunk. Further details of the gather operation are shown in FIG. 4B.

FIG. 4B shows a gather 430 operation, which is illustrative of the gather 420B operation of FIG. 4A. FIG. 4B shows a first computer system 430A that includes a first weight matrix chunk 430B, a second computer system 430C that includes a second weight matrix chunk 430D, a third computer system 430E that includes a third weight matrix chunk 430F, and a fourth computer system 430G that includes a fourth weight matrix chunk 430H.

The first computer system 430A also includes a first activation matrix chunk 430B. The second computer system 430C also includes a second activation matrix chunk 435B. The third computer system also includes a third activation matrix chunk 435C. The fourth computer system 430G also includes a fourth activation matrix chunk 435D. The activation matrix chunks will remain stationary at each computer system. In contrast, the weight matrix chunks will be transmitted amongst the various different computer systems.

For instance, computer system 430A will initially perform a first matrix multiplication operation using the first activation matrix chunk 435A and the first weight matrix chunk 430B. In an overlapping manner with respect to the computation, computer system 430A will acquire the second weight matrix chunk 430D (or perhaps the third or fourth as the ordering does not matter). Computer system 430A will then perform the first matrix multiplication operation again using the first activation matrix chunk 435A and the second weight matrix chunk 430D.

In an overlapping manner with respect to the computation, computer system 430A will acquire the fourth weight matrix chunk 430H. Computer system 430A will then perform the first matrix multiplication operation again using the first activation matrix chunk 435A and the fourth weight matrix chunk 430H. In this manner, all chunks of the weight matrix will be used to operate on whatever chunk or portion of the activation matrix the computer system 430A has. Computer systems 430C, 430E, and 430G will perform similar operations using the various chunks of the weight matrix on their respective chunks of the activation matrix.

Returning to FIG. 4A, eventually, an output 420C is produced from the row parallel GEMM operation 420A, and this output 420C is used for the activation function 420D, which also produces an output 420E. The activation function 420D involves performing a pointwise activation computation on the output 420C.

Device 405 then performs a row parallel GEMM operation 420F, which again includes gathering respective weights (e.g., as shown by weight 420H) from the various different devices, as shown by gather 420G. The result of the row parallel GEMM operation 420F is an activation matrix 420I, which is not a complete activation matrix inasmuch as its dimensions are still (S/2, B, h). Notably, the weights represented by weight 420H are different than the weights represented by weight matrix 415B. As described in more detail below, the sizes of the weight chunks represented by the weight 420H are different than the sizes of the weight chunks represented by the weight matrix 415B. The values of the weights represented by weight 420H are also different than the values of the weights represented by weight matrix 415B.

The row parallel GEMM operation 420F corresponds to the second matrix multiplication operation 345 shown in FIG. 3. The computation and communication that happens in the second GEMM (i.e. the row parallel GEMM operation 420F) is identical to the first GEMM (i.e. the row parallel GEMM operation 420A).

The weight matrix of the second GEMM is typically of size (4h, h) which is sharded along the first dimension. When there are P devices, each device has a weight shard of size (4h/P, h). The activations that arrive at the input of the second GEMM are already sharded, since the first GEMM and the pointwise activation computation (i.e. the activation function 420D) were performed in a sharded fashion. Each activation shard is of size (S/P, B, 4h).

Each device then performs its computation in an activation stationary fashion, similar to the first GEMM. Activation shards stay stationary on each device, while the weights are communicated in a ring fashion overlapping with the computation.

The difference between the two GEMMs is the size of the activation and weight matrices. For the first GEMM, the sharded input activation is typically of size (S/P, B, h) and sharded weight is of size (h/P, 4h). The output activation that gets generated is of size (S/P, B, 4h). In FIG. 4A, the activation matrix 420I is shown as being size (S/2, B, h) because two processors/devices are involved. For the second GEMM, the sharded input activation is of size (S/P, B, 4h), sharded weight is of size (4h/P, h) and the generated output activation is of size (S/P, B, h).

Similar operations are performed by device 410, as shown by row parallel GEMM operation 425A, gather 425B, output 425C, activation function 425D, output 425E, row parallel GEMM operation 425F, gather 420G, and activation matrix 425G.

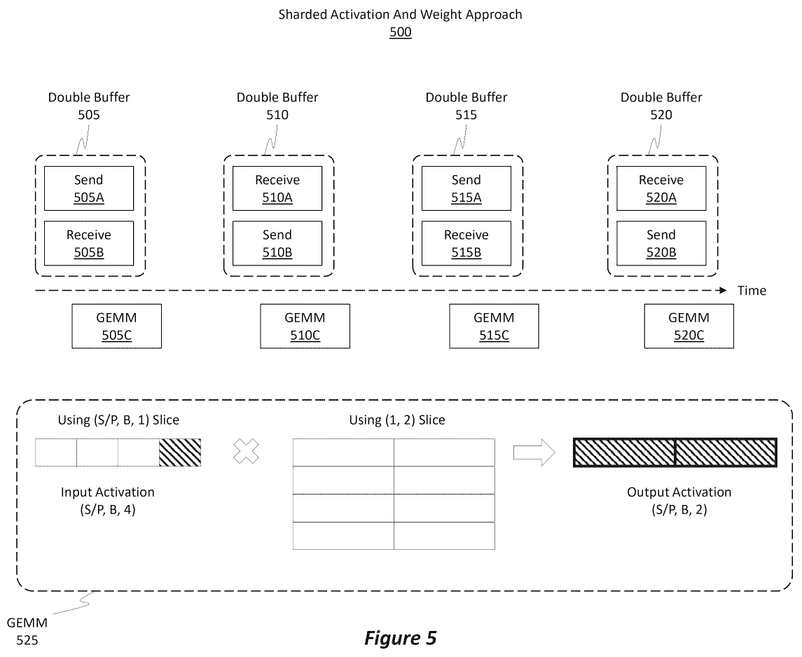

FIG. 5 provides further details on the sharded activation and weight approach 500, which corresponds to the sharded activation and weight approach 400 of FIG. 4A. FIG. 5 shows four different double buffers 505, 510, 515, and 520. Each one of these double buffers is implemented on a respective device. For example, double buffer 505 may be implemented on device 405 of FIG. 4A, and double buffer 510 may be implemented on device 410. In FIG. 5, the reference “P”refers to the number of processors that are available (in this scenario, the number is 4).

FIG. 5 particularly points out the overlapping communication and computation operations recited herein. To illustrate, the double buffer 505 is used to facilitate the gathering operations mentioned previously, which gathering involves sending a weight matrix chunk to a neighboring device (e.g., as shown by send 505A) and receiving a weight matrix chunk from a neighboring device (e.g., as shown by receive 505B). In concert or in parallel with those operations, the device also performs the first general matrix multiplication (GEMM) operation 505C, which includes the row parallel GEMM operations 420A and 425A discussed in FIG. 4A. Thus, the communication operations (e.g., send 505A and receive 505B) are interleaved with the computation operations (e.g., the GEMM operation 505C), as shown by the overlapping that is occurring along the time domain.

The second device, which includes the double buffer 510, includes similar operations, as shown by receive 510A, send 510B, and GEMM 510C. The third device, which includes the double buffer 515, includes similar operations, as shown by send 515A, receive 515B, and GEMM 515C. The fourth device, which includes the double buffer 520, includes similar operations, as shown by receive 520A, send 520B, and GEMM 520C. The various GEMM operations are also illustrated in FIG. 5 via the GEMM 525.

Thus, improvements over traditional tensor parallelism techniques are achieved by interleaving the computation operations and the computation operations. That is, the embodiments can gather or fetch chunks of the weight matrix when performing the GEMM operation. Fetching the chunks of the weight matrix in this manner enables the device to avoid having to store the entire weight matrix; instead, the device can store a limited portion of the weight matrix, such as perhaps two different chunks at any given time. The device can discard a chunk of a weight matrix after using it to perform the GEMM operation. FIG. 5 also shows how the GEMM operation is performed when the communication and reduction dimensions are shared during the forward pass. Significant benefits can especially be achieved when S>>4h.

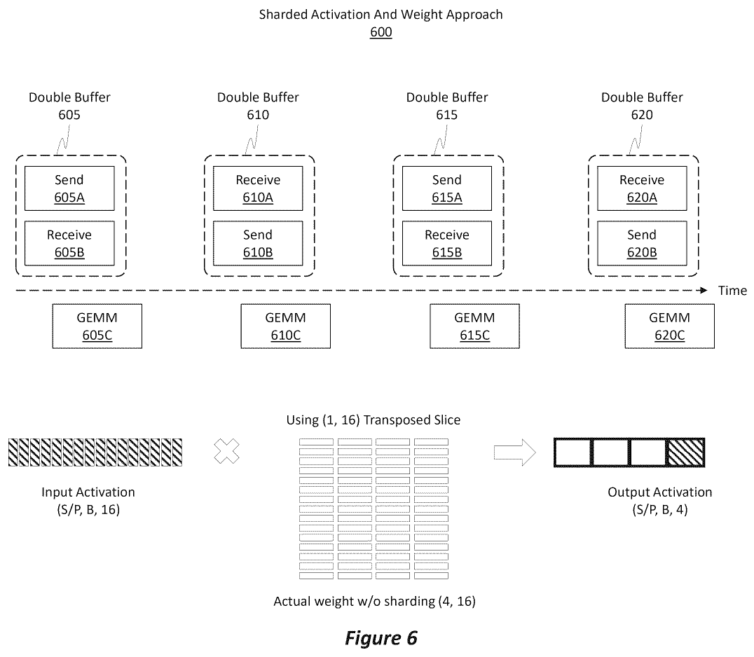

FIG. 6 shows an example scenario in which the GEMM operations are performed when the communications and the reduction dimensions are not shared, such as during the backward pass. In particular, FIG. 6 shows the sharded activation and weight approach 600 performed during the backward pass, which involves a transposed weight matrix such that chunking or sharding happens along columns.

Here, four devices have double buffers, as shown by double buffers 605, 610, 615, and 620. Each device performs communication operations, as shown by the send 605A, receive 605B, receive 610A, send 610B, send 615A, receive 615B, receive 620A, and send 620B. Each device also, in an overlapping manner, performs a GEMM operation, as shown by GEMM 605C, 610C, 615C, and 620C. The GEMM operations can be performed using transposed slices, as shown in the bottom half of FIG. 6.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

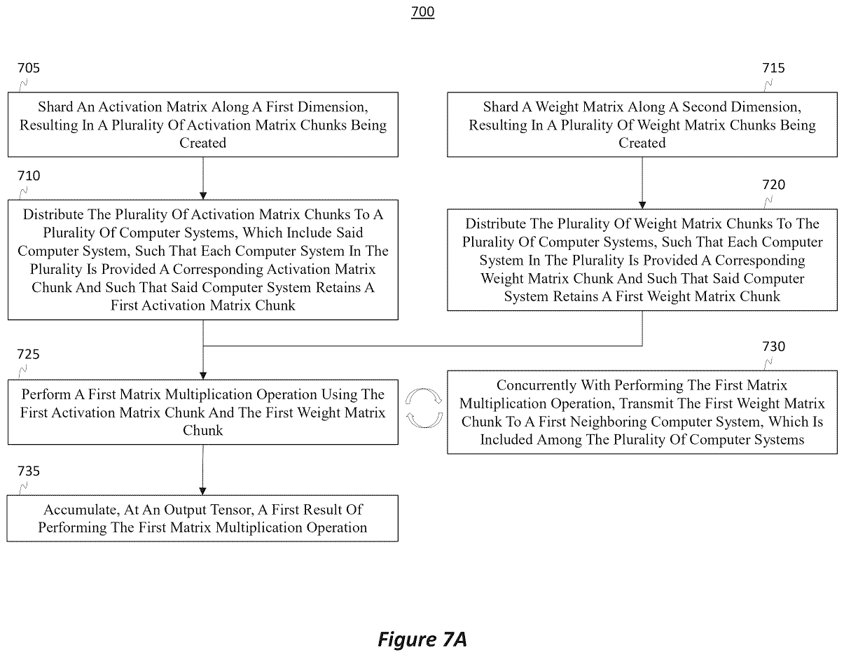

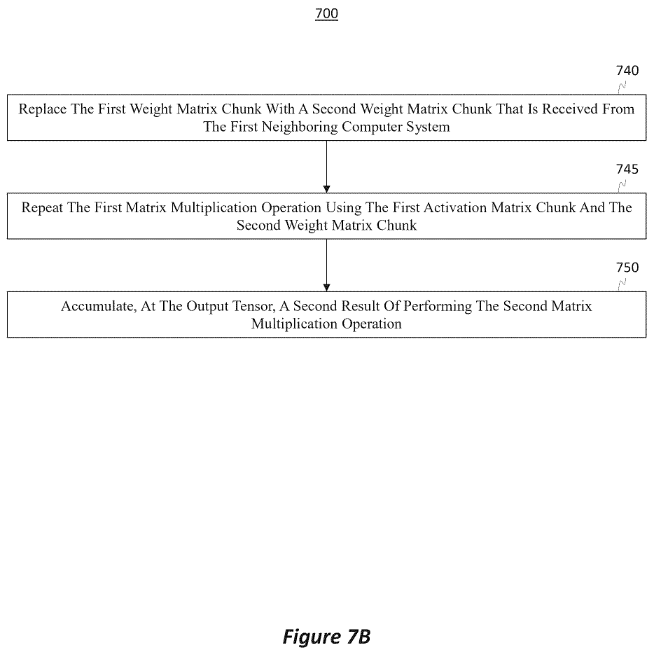

Attention will now be directed to FIGS. 7A and 7B, which illustrate a flowchart of an example method 700 for improving the training and prompt phase inferencing of a long sequence transformer. Method 700 can be implemented within the architecture 300 of FIG. 3. Also, method 700 can be performed by service 305.

Method 700 includes an act (act 705) of sharding an activation matrix along a first dimension. This sharding action results in a plurality of activation matrix chunks being created. Optionally, the first dimension is a sequence dimension of the activation matrix, and the activation matrix may further include a hidden dimension. Sharding the activation matrix along the first dimension may be performed using either a block split or a cyclic split.

Act 710 includes distributing the plurality of activation matrix chunks to a plurality of computer systems, which include the computer system performing method 700. As a result, each computer system in the plurality is provided a corresponding activation matrix chunk, and the computer system executing method 700 retains a first activation matrix chunk.

In parallel, in serial, or in an asynchronous manner relative to acts 705 and 710, act 715 includes sharding a weight matrix along a second dimension. This sharding action results in a plurality of weight matrix chunks being created.

Act 720 includes distributing the plurality of weight matrix chunks to the plurality of computer systems. As a result, each computer system in the plurality is provided a corresponding weight matrix chunk. Also, the computer system executing method 700 retains a first weight matrix chunk.

In some implementations, the sizes of the plurality of activation matrix chunks are equal. Similarly, in some implementations, the sizes of the plurality of weight matrix chunks are equal. A number of activation matrix chunks in the plurality may be dependent on a number of computer systems that are included in the plurality of computer systems and that are identified as being available to operate using the plurality of activation matrix chunks. In large sequence transformers, the size of the activation matrix is larger (much larger, such as more than 4 times) than a size of the weight matrix.

The activation matrix can be operational as being a two-dimensional matrix, such as by ignoring the “B” dimension. Similarly, the weight matrix can be operational as being a two-dimensional matrix. The number of the plurality of activation matrix chunks is equal to the number of the plurality of weight matrix chunks.

Act 725 includes performing a first matrix multiplication operation using the first activation matrix chunk and the first weight matrix chunk. For instance, the row parallel GEMM operation 420A of FIG. 4A is representative of this first matrix multiplication operation.

Concurrently with (i.e. in an overlapping manner with) performing the first matrix multiplication operation, act 730 includes transmitting the first weight matrix chunk (or at least a copy) to a first neighboring computer system, which is included among the plurality of computer systems. Notably, the first activation matrix chunk remains stationary on the computer system. Also concurrently with performing the first matrix multiplication operation, a second weight matrix chunk is received by the computer system from another computer system.

Act 735 includes accumulating, at an output tensor, a first result of performing the first matrix multiplication operation.

Method 700 continues in FIG. 7B. Method 700 includes an act (act 740) of replacing the first weight matrix chunk with a second weight matrix chunk that is received from the first neighboring computer system. Notably, at any given time, no more than two weight matrix chunks are stored on the computer system.

The second weight matrix chunk is received in an asynchronous manner from the first neighboring computer system. In some scenarios, the second weight matrix chunk is transmitted from the first neighboring computer system while the first matrix multiplication operation is being performed using the first activation matrix chunk and the first weight matrix chunk. Optionally, the transmission of the second weight matrix chunk is initiated by the first neighboring computer system while the first matrix multiplication operation is being performed using the first activation matrix chunk and the first weight matrix chunk on the computer system.

Act 745 includes repeating the first matrix multiplication operation using the first activation matrix chunk and the second weight matrix chunk.

Act 750 then includes accumulating, at the output tensor, a second result of performing the second matrix multiplication operation. If only two weight matrix chunks are involved, then the output 420C of FIG. 4A is produced. If more than two weight matrix chunks are involved, then the process will continue, as described below.

In some implementations, method 700 can include some additional acts that are now shown in FIGS. 7A and 7B. For instance, one act can include identifying a number of computer systems that are included in the plurality of computer systems. Another act can include determining that a number of weight matrix chunks is the same as the number of computer systems.

Based on the number of weight matrix chunks, the embodiments may then perform the following steps. For instance, a first step (i) involves replacing a current weight matrix chunk stored by the computer system with a new weight matrix chunk obtained from a different computer system. A second step (ii) involves repeating the first matrix multiplication operation using the first activation matrix chunk and the new weight matrix chunk. The embodiments may then repeat steps (i) and (ii) until all weight matrix chunks from the plurality of computer systems are used as a part of the first matrix multiplication operation, resulting in a final output tensor. After all weight matrix chunks are involved in the first matrix multiplication operation, the output 420C of FIG. 4A is produced.

The embodiments may then perform a pointwise activation computation on the final output tensor (e.g., the output 420C in FIG. 4A). After the pointwise activation computation is performed (resulting in output 420E in FIG. 4A), the embodiments may then perform a second matrix multiplication operation (e.g., row parallel GEMM 420F) using an output activation matrix chunk included in the final output tensor. The process of performing the second matrix multiplication includes iteratively gathering (e.g., gather 420G) new weight matrix chunks (e.g., weight 420H) and iteratively matrix multiplying each one of the new weight matrix chunks against the output activation matrix chunk, resulting in generation of a final activation matrix chunk (e.g., activation 420I). Thus, the embodiments can perform a pointwise activation computation and then perform a second matrix multiplication operation.

By performing the disclosed operations, the computer system avoids performing a single shot computation. Instead, the computer system performs a tiling operation as a result of operating on the first activation matrix chunk using weight matrix chunks that are individually and successively obtained.

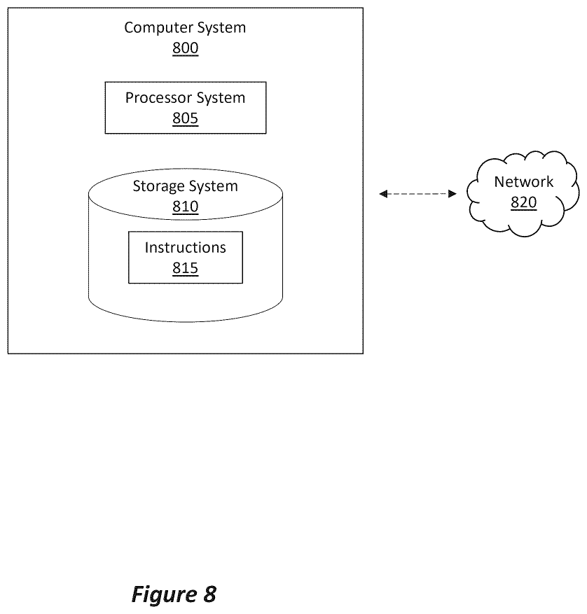

Attention will now be directed to FIG. 8 which illustrates an example computer system 800 that may include and/or be used to perform any of the operations described herein. For instance computer system 800 can be used to implement architecture 300 of FIG. 3. Also, computer system 800 can implement service 305.

Computer system 800 may take various different forms. For example, computer system 800 may be embodied as a tablet, a desktop, a laptop, a mobile device, or a standalone device, such as those described throughout this disclosure. Computer system 800 may also be a distributed system that includes one or more connected computing components/devices that are in communication with computer system 800.

In its most basic configuration, computer system 800 includes various different components. FIG. 8 shows that computer system 800 includes a processor system 805, which includes one or more processor(s) (aka a “hardware processing unit”) and a storage system 810.

Regarding the processor(s) of the processor system 805, it will be appreciated that the functionality described herein can be performed, at least in part, by one or more hardware logic components (e.g., the processor(s)). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 800. The different components, modules, engines, and services described herein may be implemented as objects or processors that execute on computer system 800 (e.g. as separate threads).

Storage system 810 may be physical system memory, which may be volatile, non-volatile, or some combination of the two. The term “memory” may also be used herein to refer to non-volatile mass storage such as physical storage media. If computer system 800 is distributed, the processing, memory, and/or storage capability may be distributed as well.

Storage system 810 is shown as including executable instructions 815. The executable instructions 815 represent instructions that are executable by the processor(s) of computer system 800 to perform the disclosed operations, such as those described in the various methods.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device. ” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 800 may also be connected (via a wired or wireless connection) to external sensors (e.g., one or more remote cameras) or devices via a network 820. For example, computer system 800 can communicate with any number devices or cloud services to obtain or process data. In some cases, network 820 may itself be a cloud network. Furthermore, computer system 800 may also be connected through one or more wired or wireless networks to remote/separate computer systems(s) that are configured to perform any of the processing described with regard to computer system 800.

A “network,” like network 820, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 800 will include one or more communication channels that are used to communicate with the network 820. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system comprising:
a processor system; and
a storage system that includes instructions that are executable by the processor system to cause the computer system to:
shard an activation matrix along a first dimension, resulting in a plurality of activation matrix chunks being created;
distribute the plurality of activation matrix chunks to a plurality of computer systems, which include said computer system, such that each computer system in the plurality is provided a corresponding activation matrix chunk and such that said computer system retains a first activation matrix chunk;
shard a weight matrix along a second dimension, resulting in a plurality of weight matrix chunks being created;
distribute the plurality of weight matrix chunks to the plurality of computer systems, such that each computer system in the plurality is provided a corresponding weight matrix chunk and such that said computer system retains a first weight matrix chunk;
perform a first matrix multiplication operation using the first activation matrix chunk and the first weight matrix chunk;
concurrently with performing the first matrix multiplication operation, transmit the first weight matrix chunk to a first neighboring computer system, which is included among the plurality of computer systems;
accumulate, at an output tensor, a first result of performing the first matrix multiplication operation;
replace the first weight matrix chunk with a second weight matrix chunk that is received from the first neighboring computer system;
repeat the first matrix multiplication operation using the first activation matrix chunk and the second weight matrix chunk; and
accumulate, at the output tensor, a second result of performing the second matrix multiplication operation.

2. The computer system of claim 1, wherein the instructions are further executable to cause the computer system to:
identify a number of computer systems that are included in the plurality of computer systems;
determine that a number of weight matrix chunks is the same as the number of computer systems;
based on the number of weight matrix chunks, perform the following:
(i) replace a current weight matrix chunk stored by the computer system with a new weight matrix chunk obtained from a different computer system;
(ii) repeat the first matrix multiplication operation using the first activation matrix chunk and the new weight matrix chunk; and
(iii) repeat steps (i) and (ii) until all weight matrix chunks from the plurality of computer systems are used as a part of the first matrix multiplication operation, resulting in a final output tensor; and
perform a pointwise activation computation on the final output tensor.

3. The computer system of claim 2, wherein the instructions are further executable to cause the computer system to:
perform a second matrix multiplication operation using an output activation matrix chunk included in the final output tensor, wherein performing the second matrix multiplication includes iteratively gathering new weight matrix chunks and iteratively matrix multiplying each one of the new weight matrix chunks against the output activation matrix chunk, resulting in generation of a final activation matrix chunk.

4. The computer system of claim 1, wherein sizes of the plurality of activation matrix chunks are equal, and wherein sizes of the plurality of weight matrix chunks are equal.

5. The computer system of claim 1, wherein a number of activation matrix chunks in the plurality is dependent on a number of computer systems that are included in the plurality of computer systems and that are identified as being available to operate using the plurality of activation matrix chunks.

6. The computer system of claim 1, wherein the activation matrix is operational as being a two-dimensional matrix.

7. The computer system of claim 1, wherein the weight matrix is operational as being a two-dimensional matrix.

8. The computer system of claim 1, wherein the first dimension is a sequence dimension of the activation matrix, and wherein the activation matrix further includes a hidden dimension.

9. The computer system of claim 1, wherein sharding the activation matrix along the first dimension is performed using either a block split or a cyclic split.

10. The computer system of claim 1, wherein the first activation matrix chunk remains stationary on the computer system.

11. The computer system of claim 1, wherein a size of the activation matrix is larger than a size of the weight matrix.

12. The computer system of claim 1, wherein the second weight matrix chunk is received in an asynchronous manner from the first neighboring computer system.

13. The computer system of claim 1, wherein the second weight matrix chunk is transmitted from the first neighboring computer system while the first matrix multiplication operation is being performed using the first activation matrix chunk and the first weight matrix chunk.

14. The computer system of claim 1, wherein transmission of the second weight matrix chunk is initiated by the first neighboring computer system while the first matrix multiplication operation is being performed using the first activation matrix chunk and the first weight matrix chunk on said computer system.

15. The computer system of claim 1, wherein, at any given time, no more than two weight matrix chunks are stored on the computer system.

16. The computer system of claim 1, wherein the computer system avoids performing a single shot computation and instead performs a tiling operation as a result of operating on the first activation matrix chunk using weight matrix chunks that are individually and successively obtained.

17. The computer system of claim 1, wherein the instructions are further executable to cause the computer system to:
perform a pointwise activation computation; and
perform a second matrix multiplication operation.

18. The computer system of claim 1, wherein a number of the plurality of activation matrix chunks is equal to a number of the plurality of weight matrix chunks.

19. A method comprising:
sharding an activation matrix along a first dimension, resulting in a plurality of activation matrix chunks being created;
distributing the plurality of activation matrix chunks to a plurality of computer systems, which include a computer system, such that each computer system in the plurality is provided a corresponding activation matrix chunk and such that said computer system retains a first activation matrix chunk;
sharding a weight matrix along a second dimension, resulting in a plurality of weight matrix chunks being created;
distributing the plurality of weight matrix chunks to the plurality of computer systems, such that each computer system in the plurality is provided a corresponding weight matrix chunk and such that said computer system retains a first weight matrix chunk;
performing a first matrix multiplication operation using the first activation matrix chunk and the first weight matrix chunk;
concurrently with performing the first matrix multiplication operation, transmitting the first weight matrix chunk to a first neighboring computer system, which is included among the plurality of computer systems;
accumulating, at an output tensor, a first result of performing the first matrix multiplication operation;
replace the first weight matrix chunk with a second weight matrix chunk that is received from the first neighboring computer system;
repeating the first matrix multiplication operation using the first activation matrix chunk and the second weight matrix chunk; and
accumulating, at the output tensor, a second result of performing the second matrix multiplication operation.

20. One or more hardware storage devices that store instructions that are executable by one or more processors to cause the one or more processors to:
shard an activation matrix along a first dimension, resulting in a plurality of activation matrix chunks being created;
distribute the plurality of activation matrix chunks to a plurality of computer systems, which include a computer system, such that each computer system in the plurality is provided a corresponding activation matrix chunk and such that said computer system retains a first activation matrix chunk;
shard a weight matrix along a second dimension, resulting in a plurality of weight matrix chunks being created;
distribute the plurality of weight matrix chunks to the plurality of computer systems, such that each computer system in the plurality is provided a corresponding weight matrix chunk and such that said computer system retains a first weight matrix chunk;
perform a first matrix multiplication operation using the first activation matrix chunk and the first weight matrix chunk;
concurrently with performing the first matrix multiplication operation, transmit the first weight matrix chunk to a first neighboring computer system, which is included among the plurality of computer systems;
accumulate, at an output tensor, a first result of performing the first matrix multiplication operation;
replace the first weight matrix chunk with a second weight matrix chunk that is received from the first neighboring computer system;
repeat the first matrix multiplication operation using the first activation matrix chunk and the second weight matrix chunk; and
accumulate, at the output tensor, a second result of performing the second matrix multiplication operation.
